(19) United States
(12) Patent Application Publication
(10) Pub. No.: US 2008/0078569 A1
(43) Pub. Date: Apr. 3, 2008

(54) Electric conductor and circuit unit using the same

(76) Inventors: Matsuhisa Tsuruta, Toyota-city (JP); Takao Niimi, Anjo-city (JP)

Correspondence Address: BUCHANAN, INGERSOLL & ROONEY PC, POST OFFICE BOX 1404, ALEXANDRIA, VA, 22313-1404, US

(21) Appl. No.: 11/902,776

(22) Filed: Sep. 25, 2007

(30) Foreign Application Priority Data
Oct. 2, 2006 (JP) 2006-270632

(51) Int. Cl. H01B 5/02

(52) U.S. Cl. 174/133 B

(57) ABSTRACT

A bus bar as electric conductor is formed to a shape which follows a predetermined circuit path including bent portions, by bending a metal-made plate-like member spreading in a single plane. The plate-like member is made as a single integral member and comprises a first elongate portion formed linearly and constituting a first path portion of the bus bar including the bent portions by being bent from the state in which the first elongate portion lies in a plane. The plate-like member further comprises a second elongate portion formed linearly and constituting a second path portion of the bus bar and a tying portion tying the first elongate portion and the second elongate portion so that an extending direction of the first elongate portion makes a first predetermined angle with an extending direction of the second elongate portion. The tying portion is bent so that a plane including the second elongate portion makes a second predetermined angle with a plane including the first elongate portion.

### INCORPORATION BY REFERENCE

This application is based on and claims priority under 35 U.S.C. 119 with respect to Japanese Application No. 2006-270632 filed on Oct. 2, 2006, the entire content of which is incorporated herein by reference.

### BACKGROUND OF THE INVENTION

1. Field of the Invention

The present invention relates to an electric conductor formed to a shape which follows a predetermined circuit path with bent portions, and attached to a base portion. It also relates to a circuit unit composed of the base portion and the electric conductor.

2. Discussion of the Related Art

As electric conductors of this kind, there has been known one disclosed in Japanese unexamined, published patent application No. 2000-159083. As shown in FIG. 4 of the application, a bus bar (electric conductor) 19 for an ECU-integrated hydraulic control device is formed by a metal plate taking a bent shape and made of, e.g., copper, and is used for a high-current circuit (e.g., as high as 12 volts, 80 amperes). The bus bar 19 is attached to a low bed portion 13a of a bulkhead 13 provided as a part of a housing 7.

The electric conductor described in the aforementioned Japanese application takes a bent and complicated shape within a single plane. Therefore, where the electric conductor of the shape so complicated is blanked out in a sequential transfer line, a problem arises in that the yield is deteriorated to increase the manufacturing cost.

### SUMMARY OF THE INVENTION

Accordingly, it is a primary object of the present invention to provide an improved electric conductor and a circuit unit employing the same wherein the electric conductor can be formed to a shape which follows a predetermined circuit path with bent portions, without deteriorating the yield in manufacturing and hence, without increasing the manufacturing cost.

Briefly, according to a first aspect of the present invention, there is provided an electric conductor formed to a shape which follows a predetermined circuit path including bent portions by bending a metal-made plate-like member spreading in a single plane and attachable to a base portion of a device. The plate-like member is made as a single integral member and comprises a first elongate portion formed linearly and constituting a first path portion of the electric conductor including the bent portions by being bent from the state in which the first elongate portion lies in a plane. The plate-like member further comprises a second elongate portion formed linearly and constituting a second path portion of the electric conductor and a tying portion tying the first elongate portion and the second elongate portion so that an extending direction of the first elongate portion makes a first predetermined angle with an extending direction of the second elongate portion. The tying portion is bent so that a plane including the second elongate portion makes a second predetermined angle with a plane including the first elongate portion.

With the construction in the first aspect of the invention, the plate-like member is formed approximately linearly because the first and second elongate portions each extending linearly are tied at the first predetermined angle close to zero degree. Thus, where a plurality of plate-like members taking the same shape as the aforementioned plate-like member are blanked out in a sequential transfer line, the interval between two adjoining plate-like members can be made to be short, and therefore, it can be realized to suppress the deterioration in the yield in comparison with that in a prior art and hence, to suppress an increase in the manufacturing cost. Then, by bending the plate-like member, there can be formed an electric conductor of the shape which follows the predetermined circuit path including the bent portions. Therefore, the electric conductor can be formed to the shape which follows the predetermined circuit path including the bent portions, without deteriorating the yield and hence, without increasing the manufacturing cost. In addition, since the first elongate portion is bent from the state in which it lies in a plane, it is possible to arbitrarily set the circuit path of the electric conductor.

According to a second aspect of the present invention, there is provided a circuit unit which comprises a base portion of the circuit unit and an electric conductor formed to a shape which follows a predetermined circuit path including bent portions by bending a metal-made plate-like member spreading in a single plane and attached to the base portion. The plate-like member is made as a single integral member and comprises a first elongate portion formed linearly and constituting a first path portion of the electric conductor including the bent portions by being bent from the state in which the first elongate portion lies in a plane. The plate-like member further comprises a second elongate portion formed linearly and constituting a second path portion of the electric conductor and a tying portion tying the first elongate portion and the second elongate portion so that an extending direction of the first elongate portion makes a first predetermined angle with an extending direction of the second elongate portion. The tying portion is bent so that a plane including the second elongate portion makes a second predetermined angle with a plane including the first elongate portion.

With the construction in the second aspect of the invention, there can be attained the same effects as those attained by the first aspect of the invention.

### BRIEF DESCRIPTION OF THE ACCOMPANYING DRAWINGS

The foregoing and other objects and many of the attendant advantages of the present invention may readily be appreciated as the same becomes better understood by reference to the preferred embodiment of the present invention when considered in connection with the accompanying drawings, wherein like reference numerals designate the same or corresponding parts throughout several views, and in which:

FIG. 1 is a schematic view partly in section of a hydraulic brake device wherein an electric conductor or bus bar and a circuit unit in one embodiment according to the present invention are employed in a brake fluid pressure control device for motor vehicles;

FIG. 2 is a plan view showing the manner in which the bus bar is attached to a case of the brake fluid pressure control device;

FIG. 3 is a longitudinal sectional view of the brake fluid pressure control device taken along the line 3-3 in FIG. 2;

FIGS. 4(a) and 4(b) are a plan view and a front view of the bus bar, respectively;

FIG. 5 is a plan view of plate-like members on a blank each forming the bus bar;

FIG. 6 is a plan view of plate-like members on a blank each forming a bus bar in a modified (first modified) form;

FIG. 7 is a plan view showing the manner in which a bus bar in another (second) modified form is attached to the case of the brake fluid pressure control device;

FIG. 8 is a longitudinal sectional view of the brake fluid pressure control device taken along the line 8-8 in FIG. 7;

FIG. 9 is a plan view showing plate-like members on a blank each forming the bus bar shown in FIGS. 7 and 8;

FIG. 10 is a plan view showing the manner in which a bus bar in still another (third) modified form is attached to the case of the brake fluid pressure control device;

FIG. 11 is a longitudinal sectional view of the brake fluid pressure control device taken along the line 11-11 in FIG. 10;

FIG. 12 is a plan view showing plate-like members on a blank each forming the bus bar shown in FIGS. 10 and 11;

FIG. 13 is a plan view showing plate-like members on a blank each forming a bus bar in a further (fourth) modified form;

FIG. 14 is a front view of a bus bar in a still further (fifth) modified form;

FIG. 15 is a plan view of a bus bar in an yet further (sixth) modified form; and

FIGS. 16(a) and 16(b) are a plan view and a front view of a bus bar in a compared example, respectively.

### DETAILED DESCRIPTION OF THE PREFERRED EMBODIMENT

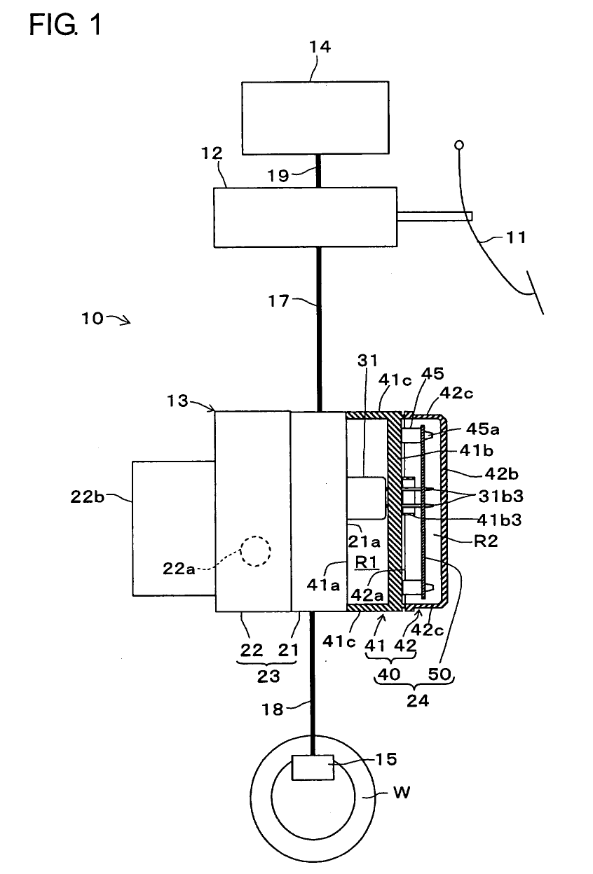

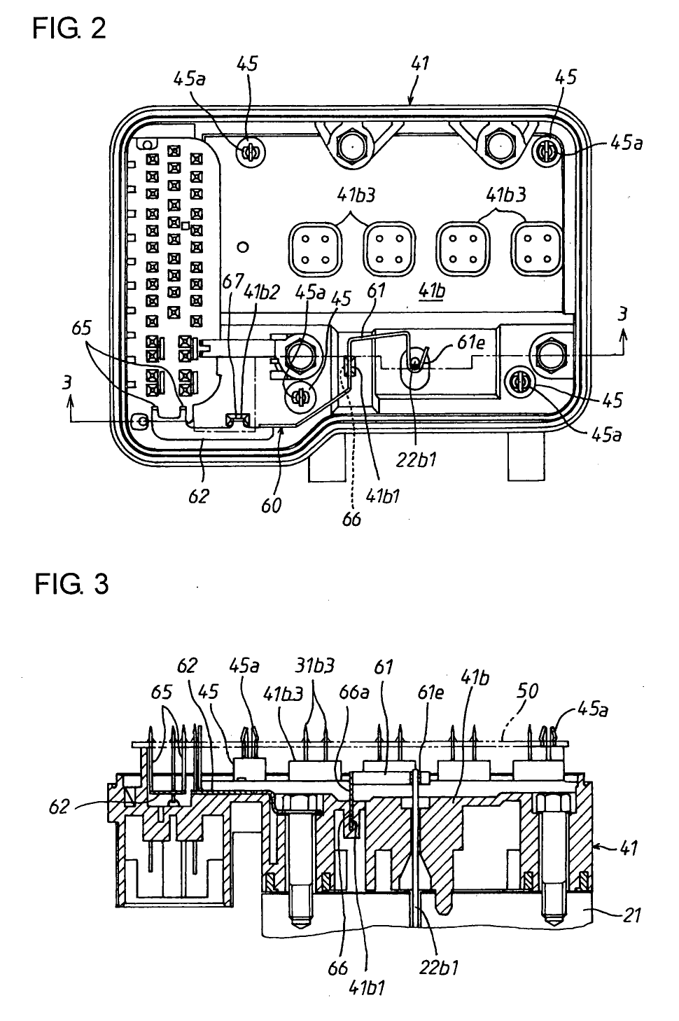

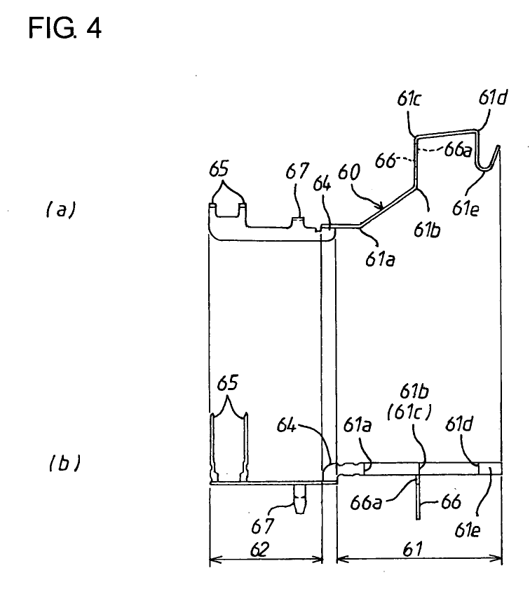

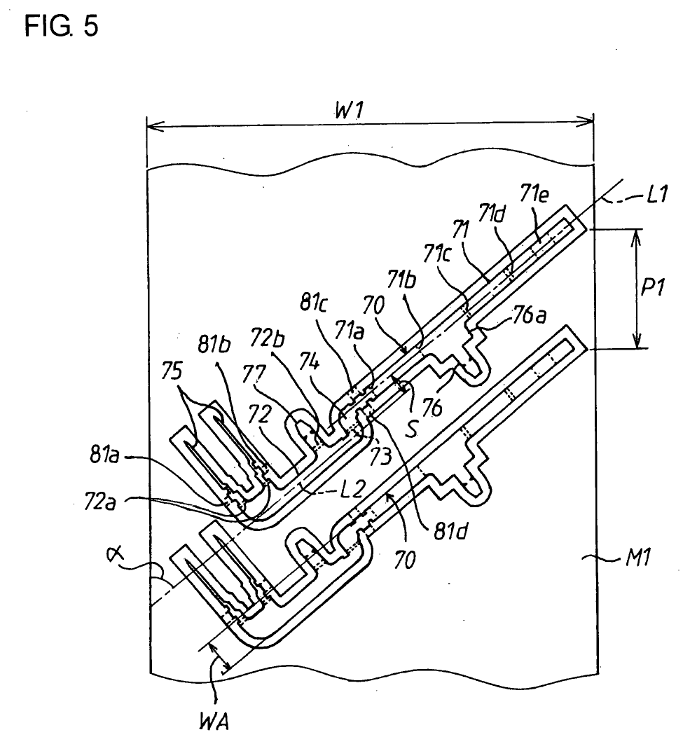

Hereafter, a vehicle brake fluid pressure control device mounting thereon an electric conductor or bus bar and a circuit unit in one embodiment according to the present invention will be described with reference to the drawings. FIG. 1 schematically shows a hydraulic brake device 10 which incorporates the vehicle brake fluid pressure control device 13. FIG. 2 is a plan view showing the state in which the bus bar is attached to a case of the vehicle brake fluid pressure control device 13. FIG. 3 is a sectional view taken along the line 3-3 in FIG. 2. FIGS. 4(a) and 4(b) are plan and front views of the bus bar, respectively. FIG. 5 is a plan view showing plate-like members on a blank each forming the bus bar.

The hydraulic brake device 10 is for applying brake forces to wheels W of a vehicle (not shown). As shown in FIG. 1, the hydraulic brake device 10 is provided with a master cylinder 12, the vehicle brake fluid pressure control device 13, a reservoir tank 14 and brakes (wheel cylinders) 15. The brakes (wheel cylinders) 15 and wheels W associated therewith are usually provided as four sets for a conventional four wheel vehicle and are shown in FIG. 1 as those for one wheel for simplicity in illustration. The master cylinder 12 generates a hydraulic pressure corresponding to the brake manipulation state in which a brake pedal 11 is stepped in, and supplies the hydraulic pressure to the brakes 15 for restricting the rotations of the wheels W of the vehicle.

The vehicle brake fluid pressure control device 13 is of a single body structure and is composed of a brake actuator 23 which is in turn composed of a solenoid block 21 and a pump block 22, and a casing unit 24. The reservoir tank 14 stores brake fluid and supplies the same to the master cylinder 12 and the brake actuator 23. The reservoir tank 14 replenishes the brake fluid to the master cylinder 12 through conduits 19.

The solenoid block 21 is in fluid communication with the master cylinder 12 through conduits 17 on one hand and with the brakes 15 through conduits 18 on the other hand. The solenoid block 21 has formed therein oil passages which are connected to the respective conduits 17, 18 and a pump 22a built in the pump block 22. The solenoid block 21 is made of a metal material.

Although being illustrated as one solenoid valve in FIG. 1, a plurality of solenoid valves 31 being electromagnetic valves which operate as retention valves, reduction valves, control valves and the like, and pressure sensors (not shown) for detecting hydraulic pressures at various parts are incorporated in the solenoid block 21 to be arranged on the aforementioned oil passages. Thus, operations can be performed so that the hydraulic pressure from the master cylinder 12 is supplied to the predetermined brakes 15 and/or the hydraulic pressures controlled by the solenoid valves are supplied to respective brakes 15.

The solenoid valves 31 are attached to the solenoid block 21 with solenoid sections thereof protruding into a first chamber R1. Terminals 31b3 of the solenoid valves 31 pass through a bulkhead 41b and are soldered at their ends to a control board 50.

The pump block 22 is assembled in close contact to a surface opposite to an assembling surface 21a of the solenoid block 21. The pump block 22 is made of a metal material. Oil passages being in fluid communication with the oil passages of the solenoid block 21 are formed in the pump block 22. The pump 22a is arranged on a part of the oil passages. The pump 22a is driven by the operation of a motor 22b assembled to the pump block 22 and draws brake fluid from a reservoir (not shown) provided in the brake actuator 23.

The brake actuator 23 is provided independently of the master cylinder 12 and is capable of independently generating a hydraulic pressure corresponding to the brake manipulation state of the brake pedal 11.

The casing unit 24 is composed of a casing 40 and the control board 50. The casing 40 is composed of a case 41 and a cover 42. The case 41 takes the form of a tray with an opening 41a. The case 41 is of the configuration that a base portion 41b as a base table portion and a lateral portion 41c upstanding from the circumferential edge of the base portion 41b are bodily made of a synthetic resin. An open end (end of the lateral portion 41c) of the opening 41a is in abutting contact fluid-tightly with the assembling surface 21a of the solenoid block 21. The first chamber R1 storing the solenoid valves 31 is defined between the solenoid block 21 and the case 41.

The cover 42 takes the form of a tray with an opening 42a. The cover 42 is of the structure that a base portion 42b and a lateral portion 42c upstanding from the circumferential edge of the base portion 42b are bodily made of a synthetic resin. An open end (end of the lateral portion 42c) of the opening 42a is adhered by vibration welding or the like to an outer side wall surface of the base portion 41b of the case 41. A second chamber R2 accommodating the control board 50 is defined between the case 41 and the cover 42.

In this manner, the casing 40 has the opening 41a and is detachably attached to the solenoid block 21 to cover the solenoid valves 31, with the open end being in abutting contact fluid-tightly with the assembling surface 21a of the solenoid block 21.

Further, the base portion 41b of the case 41 constitutes the bulkhead which partitions the interior of the casing 40 into the first chamber R1 and the second chamber R2. The bulkhead 41b is arranged to face with the control board 50. As shown in FIGS. 2 and 3, dam portions 41b3 are formed on the bulkhead 41b each to surround the terminals 313b3 of a corresponding one of the solenoid valves 31. A sealing material (e.g., silicon material) is filled in each dam portion 41b3 to seal the aperture between the terminals 31b3 and the bulkhead 41.

Close to four corners of the bulkhead 41b, pillars 45 for supporting the control board 50 are formed bodily with the case 41. The pillars 45 support and hold the control board 50 through engagements of snap fasteners (snap hooks) 45a, provided on their free ends, with engaging holes formed through the control board 50.

The control board 50 is responsive to signals inputted from rotational speed sensors (not shown) or the like for detecting the rotational speeds of the wheels W and controls the motor 22b and the various solenoid valves 31 to perform various controls such as ordinary brake control, antilock brake control (ABS), side lip control (ESC: Electronic Stability Control) and the like.

A bus bar 60 as electric conductor is attached to a surface on the control board 50 side (on the second chamber R2 side) of the bulkhead 41b. The bus bar 60 is connected at its one end to a lead terminal 22b1 which is in connection to a terminal of the motor 22b, and at its other end to the control board 50. The bus bar 60 is a conductive member for supplying a voltage (electric current) from a power supply (e.g., vehicle battery) through the control board 50 to the motor 22b. The bus bar (electric conductor) 60 and the base portion (bulkhead) 41b constitute a circuit unit.

The bus bar 60 is formed to take a shape which follows a predetermined circuit path including bent portions 61a-61d by folding or bending a metal-made plate-like member 70 spreading in a single plane surface. As shown in FIG. 5, the plate-like member 70 is bodily constituted to include first and second elongate portions 71, 72, a tying portion 74 and first to third rectangular portions 75-77.

The first elongate portion 71 elongates linearly and forms the first path portion 61 by being bent from the state that it lies in a plane. More specifically, the first elongate portion 71 has a first valley bending line portion 71a, a second valley bending line portion 71b, a first mountain bending line portion 71c, a second mountain bending line portion 71d and a connection portion forming portion 71e. It is to be noted that the respective valley bending line portions and the respective mountain bending line portions do not actually exist as marks and are imaginary lines for convenience in explanation.

The first and second valley bending line portions 71a, 71b are parts for valley bending and form first and second bent portions 61a, 61b by being valley-bent. The first and second mountain bending line portions 71c, 71d are parts for mountain bending and form third and fourth bent portions 61c, 61d by being mountain-bent. The connection portion forming portion 71e is formed as a connection portion 61c by being bent along an arc of a predetermined radius. The connection portion 61e is to secure the lead terminal 22bl therein by caulking. Thus, the first path portion 61 includes the first to fourth bent portions 61a-61d and the connection portion 61e. The first to fourth bent portions 61a-61d correspond to bent points on the predetermined circuit path. Herein, the term “valley bending” means a bending state that the bending line made by bending the plate-like member 70 takes a valley form to make a smaller angle than 180 degrees between the surfaces on both sides of the bending line, as viewed from one surface of a plate material or blank M1 (i.e., as viewed in FIG. 5 from the reverse side of the drawing sheet). Conversely, the term “mountain bending” means another bending state that the bending line takes a mountain form to make a greater angle than 180 degrees between the surfaces on both sides of the bending line, as viewed in FIG. 5 from the same surface of the blank M1 or the reverse side of the drawing sheet.

The second elongate portion 72 is elongates linearly without being bent from the state in which it lies in a plane, and forms a second path portion 62 of the bus bar 60. The second path portion 62 is a linear path and is attached onto the bulkhead 41b in surface contact with the same. Herein, the term “linear” means not only a straight line but also a line with a slight unevenness or irregularity. The expression “slight unevenness or irregularity” at this passage encompasses one of the degree that the protruding amount or the depression amount does not exceed the width of the first and second elongate portions 71, 72.

The tying portion 74 ties the first elongate portion 71 with the second elongate portion 72 so that the extending directions of the first and second elongate portions 71 and 72 make a first predetermined angle θ1 therebetween (e.g., zero degree and hence, in parallel relation in this particular embodiment). The tying portion 74 includes a bending line portion 73 along which a plane including the second elongate portion 72 is bent to make a second predetermined angle θ2 (90 degrees in this particular embodiment) with respect to a plane including the first elongate portion 71. The tying portion 74 is bent at the bending line portion 73 and forms a tying portion of the bus bar 60.

The first elongate portion 71 and the second elongate portion 72 are offset from each other at the tying portion 74 in a direction perpendicular to the direction in which they extend. That is, the respective center lines L1, L2 of the first and second elongate portions 71, 72 are shifted by a predetermined distance S. The predetermined distance S is set to the value that does not make the first and second elongate portions 71, 72 overlap with each other in the direction normal to the direction in which they extend (in other words, to the value that does not make the second elongate portion 72 overlap with an imaginary extension portion which would be made by extending the first elongate portion 71 toward the side of the second elongate portion 72).

The pair of first rectangular portions 75, 75 are those which are bodily formed to extend from the second elongate portion 72 perpendicularly of the same. The first rectangular portions 75 are bent at valley bending line portions 72a and form lead terminals 65 connected to the control board 50.

The second rectangular portion 76 is an elongate one which extends from an end portion of the first elongate portion 71 perpendicularly (i.e., in a direction normal to the extending direction of the first elongate portion 71 within the same plane). The second rectangular portion 76 forms a first insert portion 66 in the state that it is not bent with respect to the first elongate portion 71. The first insert portion 66 is inserted into a first socket hole 41b1 formed in the bulkhead (base portion) 41b. Thus, the first path portion 61 of the bus bar 60 is attached and secured to the bulkhead 41b. In this particular embodiment, the second rectangular portion 76 is formed at a shoe portion 76a which protrudes from the first elongate portion 71 perpendicularly (i.e., in a direction normal to the extending direction of the first elongate portion 71 within the same plane). The shoe portion 76 functions as a spacer 66a which keeps a space between the first path portion 61 and the bulkhead 41b. It is to be noted the second rectangular portions 76 may be provided at any other portion (e.g., a center portion) than the end portion of the first elongate portion 71.

The third rectangular portion 77 extends from the second elongate portion 72 perpendicularly (in a direction normal to the second elongate portion 72 within the same plane). The third rectangular portion 77 is bent along a mountain bending line portion 72b to form a second insert portion 67. The second insert portion 67 is inserted into a second socket hole 41b2 formed in the bulkhead 41b. Thus, the second path portion 62 of the bus bar 60 is attached and secured to the bulkhead 41b.

Further, as shown in FIG. 5, each plate-like member 70 is blanked out from the blank (i.e., plate material) M1 of a width W1 at a layout angle α and an interval P1. The layout angle α is an angle which the center line L1 of the first elongate portion 71 or the center line L2 of the second elongate portion 72 makes with the longitudinal or lengthwise direction of the blank M1. The interval P1 is the distance between the same portions of two adjoining plate-like members 70 in the lengthwise direction of the blank M1. In FIG. 5, two plate-like members 70 only are illustrated, and other plate-like members 70 are omitted for simplicity in illustration.

Next, description will be made regarding the manufacturing of the plate-like member 70. The plate-like member 70 is manufactured by a sequential transfer line (not shown). First of all, the blank M1 is subjected to blanking, as shown in FIG. 5. In this state, the plate-like member 70 is left still connected to the blank M1 at four connecting portions 81a-81d. The connecting portions 81a, 81b connect the first rectangular portions 75 to the blank M1, while the connecting portions 81c, 81d connect the first elongate portion 71 to the blank M1 by the tying portion 74.

Then, from the state in which the first elongate portion 71 lies in a plane shown in FIG. 5, the first elongate portion 71 is bent by press-forming along the bending line portions 71a-71d and at the connection portion forming portion 71e to form the first path portion 61. Then, the first rectangular portions 75 are bent by press-forming to form the lead terminals 65. The connecting portions 81a, 81b are struck out prior to the press-forming of the first rectangular portions 75. Subsequently, the third rectangular portion 77 is bent by press-forming to form the second insert portion 67.

Then, the tying portion 74 is bent along the bending line portion 73 by press-forming, whereby the second elongate portion 72 is set upright at the predetermined angle θ2 (90 degrees in this particular embodiment) relative to the horizontal plane of the blank M, that is, relative to the first elongate portion 71. Thus, the bus bar 60 is formed from the plate-like member 70. Finally, the connecting portions 81c, 81d are struck out, whereby the bus bar 60 is separated from the blank M1.

As clear from the foregoing explanation, in the present embodiment, the plate-like member 70 is formed to an approximately linear shape, because the first elongate portion 71 and the second elongate portion 72 both being linear extend in parallel to each other and are mutually offset to the degree that the bending line portion 73 is secured therebetween. Thus, where the plate-like members 70 are blanked out successively in the sequential transfer line, the interval between each plate-like member 70 and the next can be minimized, so that compared with the prior art, it becomes possible to suppress the deterioration in yield and hence, to suppress an increase in the manufacturing cost.

For example, one shown as a compared example in FIG. 16 has been as an electric conductor taking the shape which follows the same circuit path as the bus bar 60 in the present embodiment. The precedent bus bar 160 is provided with a first path portion 161 extending linear and a second path portion 162 having a plurality of bent portions 162a-162c within the same plane. A connection portion 161e is formed bodily with the first path portion 161, while a pair of lead terminals 165, a first insert portion 166 and a second insert portion 167 are formed bodily with the second path portion 162. The connection portion 161e, the lead terminals 165 and the first and second insert portions 166, 167 take the same configurations as the connection portion 61e, the lead terminals 65 and the first and second insert portions 66, 67 in the present embodiment, respectively. A plate-like member which forms the precedent bus bar 160 becomes widen considerably in its width WB because of a long offset distance between the first and second path portions 161, 162, as shown in FIG. 16(a) and hence, is low in yield. In the present embodiment, on the contrary, it becomes possible to make the width WA of the plate-like member 70 narrower remarkably as shown in FIG. 5 than that WB of the precedent plate-like member.

In the manner as described above, the bus bar 60 taking the shape which follows the predetermined circuit path including the bent portions 61a-61d is formed by bending the plate-like member 70. Accordingly, it can be realized to form the bus bar 60 to the shape which follows the predetermined circuit path including the bent portions 61a-61d, without deteriorating the yield and hence, without increasing the manufacturing cost. Further, since the first elongate portion 71 is bent from the state that it lies in a plane, it can be realized to arbitrarily set the circuit path (the first path portion 61) of the bus bar 60.

Further, since the first elongate portion 71 and the second elongate portion 72 are offset at the tying portion 74 from each other in a direction perpendicular to the direction in which they extend, it can be realized to secure the bending line portion 73 certainly, to shorten the length of the bending line portion 73, and to make the machining easy.

Further, the plate-like member 70 is further provided with the first elongate rectangular portions 75 formed bodily with the second elongate portion 72 perpendicularly of the same. The first rectangular portions 75 are bent to form the lead terminals 65 which are to be connected to the control board 50 being a first connection destination. The plate-like member 70 is attached in the state that the second path portion 62 constituted by the second elongate portion 72 is held in surface contact with the base portion 41b. Thus, where a temperature change causes the lead terminals 65 to expand or contract, the stress caused by such expansion and contraction at the juncture between the control board 50 and each read terminal 65 can be relieved through elastic deformation of the second path portion 62.

Further, since the base end portions of the lead terminals 65 at the second path portion 62 are spaced away from the base portion 41b as shown in FIG. 3, it is further ensured to relieve the stress which such expansion and contraction applies to the juncture between the control board 50 being the first connection destination and each read terminal 65.

In addition, the plate-like member 70 is further provided with the second rectangular portion 76 extending from the first elongate portion 71 in a direction perpendicular thereto and being insertable into the first socket hole 41b1 formed in the base portion 41b, and a third rectangular portion 77 which forms an insert portion 67 extending from the second elongate portion 72 in a direction perpendicular thereto and bent to be insertable into the second socket hole 41b2 formed in the base portion 41b. Thus, it is possible to securely attach to the base portion 41b the bus bar 60 which is formed by bending the plate-like member 70.

(Modifications)

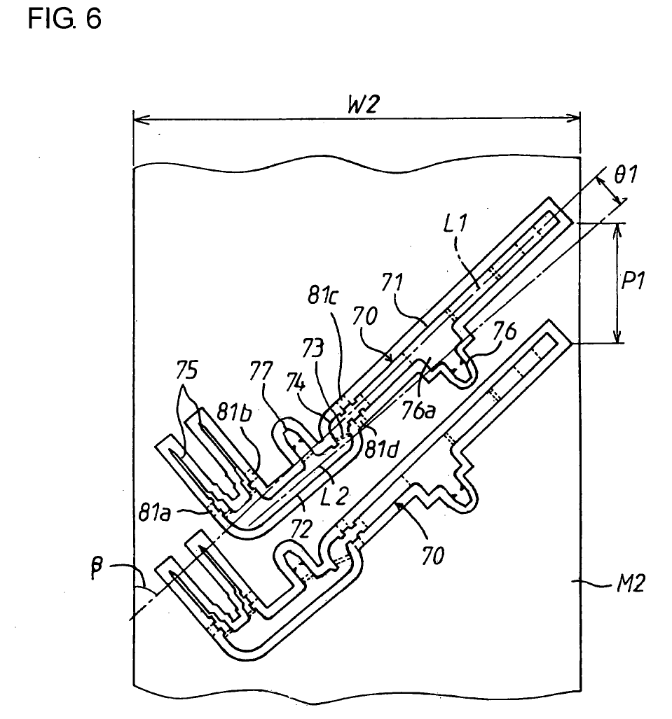

Although in the foregoing embodiment, the first predetermined angle e1 is set to zero degree, it may be set to a value which is not zero degree. In this (first) modified case, as shown in FIG. 6, the first and second elongate portions 71, 72 are tied to the tying portion 74 so that the extending direction of the first elongate portion 71 (i.e., the extending direction of the center line L1) makes a first predetermined angle θ1 greater than zero degree with the extending direction of the second elongate portion 72 (i.e., the extending direction of the center line L2).

In this (first) modified form, where the first predetermined angle θ1 is made to be greater than zero degree without the alternation in the length in the extending direction of the first elongate portion 71 (or the second elongate portion 72), the length of the plate-like member 70 in the longitudinal direction becomes shorter in comparison with that in the case of the first predetermined angle θ1 being zero degree. As a result, the plate-like members 70 can be blanked out from a blank M2 whose width W2 is narrower than the width W1 of the aforementioned blank M1, at a layout angle β and at an interval P1. Thus, since one which is narrower in width can be used as the material (blank) for the sequential transfer line, it becomes possible to reduce the material cost. The layout angle β represents the angle which the center line L1 of the first elongate portion 71 makes with the lengthwise direction of the blank M2. In FIG. 6, two plate-like members 70 only are shown, and other plate-like members are omitted from illustration for simplicity.

The first predetermined angle θ1 is set to the value which does not make the interval of the adjoining plate-like members 70 (i.e., the interval between the same portions on the adjoining plate-like members 70 in the lengthwise direction of the blank M2) become greater than the interval in the case of the first predetermined angle θ1 being set to zero degree. This advantageously results in preventing the yield from deteriorating in the case that the interval between the adjoining plate-like members 70 exceeds the interval P1.

Also in the modified form, it is preferable that the bending line portion 73 is set at an angle different from the bending line portion 73 in the aforementioned case (that is, in the case of the first predetermined angle θ1 being zero degree), and that the first path portion 61 is arranged along the upper surface of the base portion 41b.

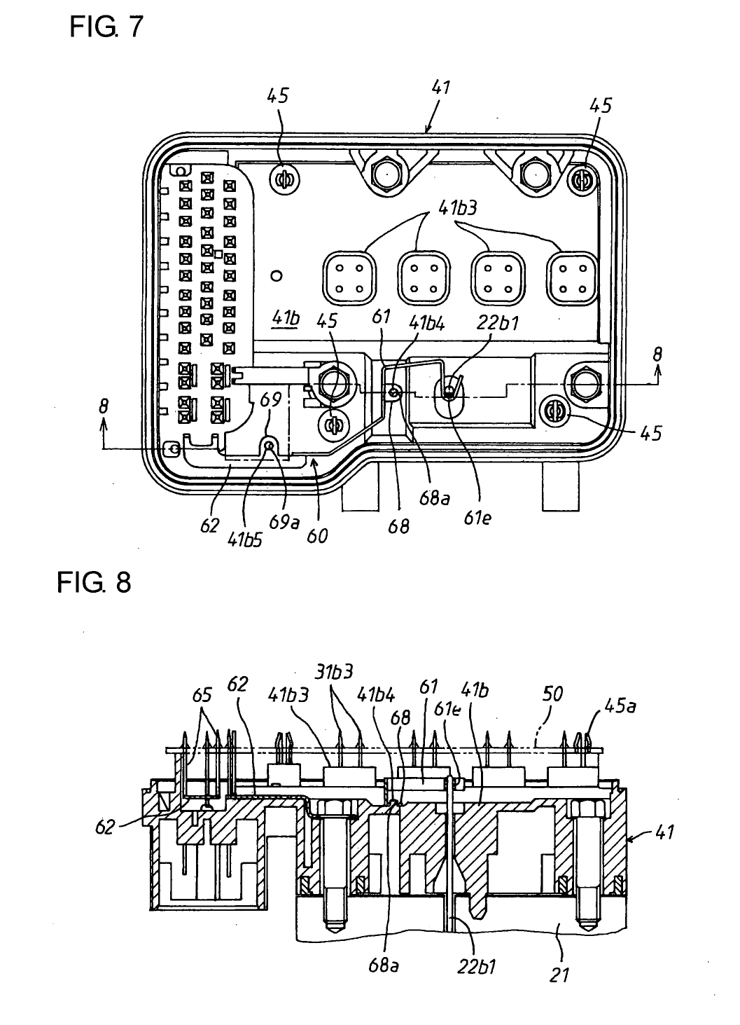

Further, in the foregoing embodiment, the bus bar 60 is attached to the base portion 41b by inserting the first and second insert portions 66, 67 of the bus bar 60 respectively into the first and second socket holes 41b1, 41b2 of the base portion 41b. Instead, in another (second) modified form, as shown in FIGS. 7 and 8, the bus bar 60 is attached to the base portion 41b by providing the bus bar 60 with first and second engaging pieces 68, 69 which respectively have first and second engaging holes 68a, 69a, by providing the base portion 41b with first and second engaging protruding portions 41b4, 41b5, and by fitting the first and second engaging pieces 68, 69 respectively on the first and second engaging protruding portions 41b4, 41b5 through the first and second engaging holes 68a, 69a.

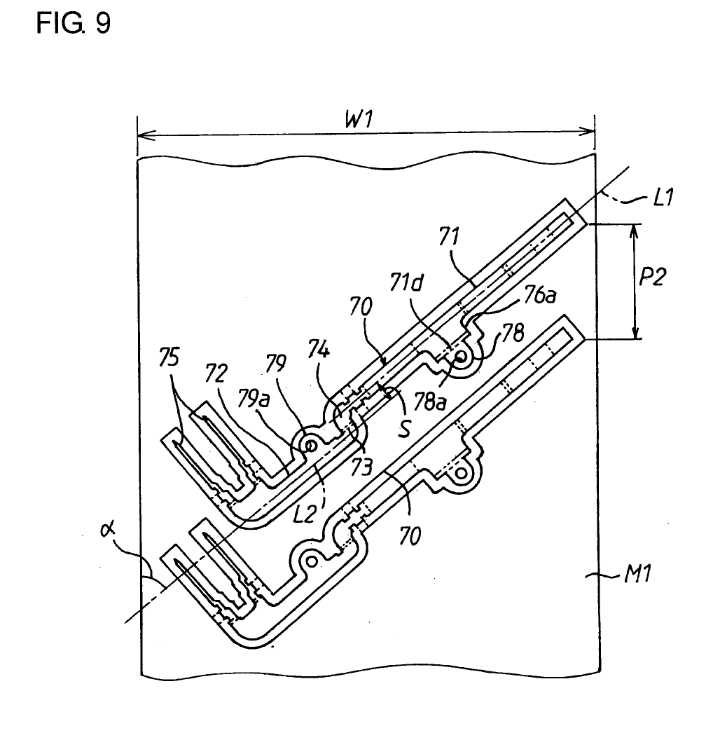

In this (second) modified form, as shown in FIG. 9, the plate-like member 70 is provided with a fourth rectangular portion 78 in place of the aforementioned second rectangular portion 76 and is also provided with a fifth rectangular portion 79 in place of the aforementioned third rectangular portion 77. Other configurations of this modified form are the same as those in the foregoing embodiment and therefore, are omitted from detailed description in exchange for the allotment of the same reference numerals thereto.

The fourth rectangular portion 78 extends from the first elongate portion 71 perpendicularly of the same (i.e., in a normal direction within the same plane) and is made to be shorter than the aforementioned second rectangular portion 76. The fourth rectangular portion 78 is bent at the mountain bending line portion 71d to form the first engaging piece 78. A hole 78a constituting the first engaging hole 68a is formed through the fourth rectangular portion 78 for engagement with the first engaging protruding portion 41b4 formed on the base portion 41b.

The fifth rectangular portion 79 extends from the second elongate portion 72 perpendicularly of the same (i.e., in a normal direction within the same plane) and is made to be shorter than the third rectangular portion 77. The fifth rectangular portion 79 forms the second engaging piece 69 with itself remaining not to be bent relative to the second elongate portion 72. A hole 79a constituting the second engaging hole 69a is formed through the fifth rectangular portion 79 for engagement with the second engaging protruding portion 41b5 formed on the base portion 41b.

Further, as shown in FIG. 9, the plate-like members 70 are blanked out from the blank M1 of the width W1 at a layout angle α and at an interval P2. As mentioned earlier, the fourth rectangular portion 78 is shorter than the aforementioned second rectangular portion 76, and therefore, the interval P2 can take a smaller value than that of the aforementioned interval P1. The interval P2 represents the interval between the same portions of the adjoining plate-like members 70 in the lengthwise direction of the blank M1. As a result, since the bus bar 60 can be reliably attached to the base portion 41b at the fourth rectangular portion 78 which is shorter than the aforementioned second rectangular portion 76, it can be realized to increase the yield in manufacturing the plate-like members 70.

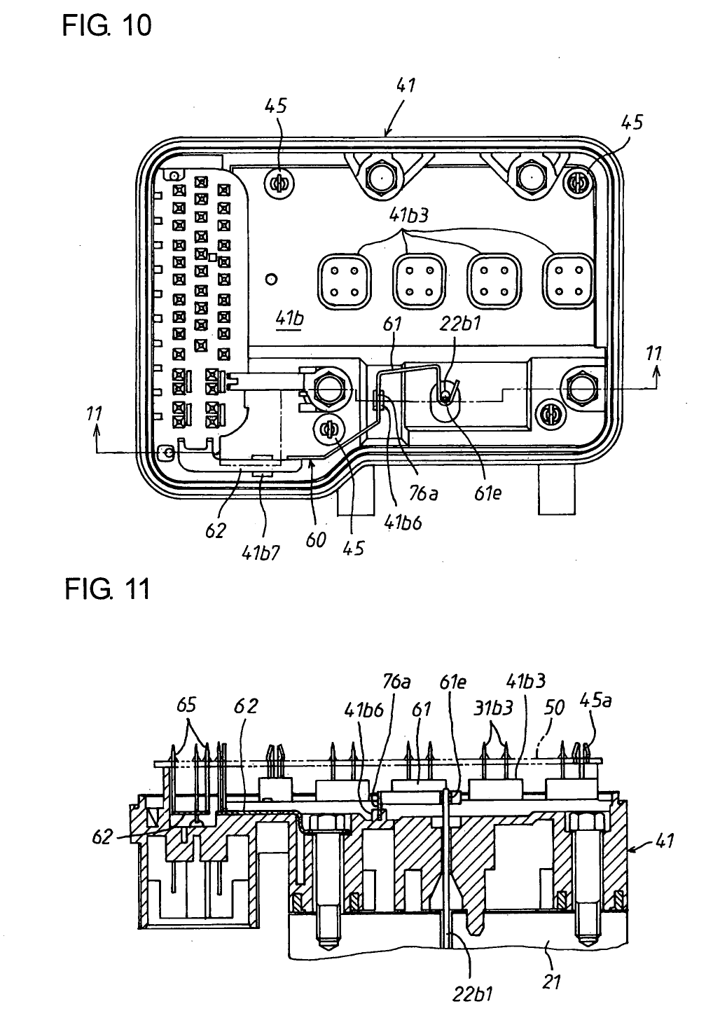

In the foregoing embodiment, the bus bar 60 is attached to the base portion 41b by inserting the first and second insert portions 66, 67 of the bus bar 60 respectively into the first and second socket holes 41b1, 41b2 of the base portion 41b. Instead, in still another (third) modified form, as shown in FIGS. 10 and 11, the bus bar 60 is attached to the base portion 41b by providing the base portion 41b with first and second holding portions 41b, 41b7 and then, by fitting the first and second path portions 61, 62, which are constituted respectively by the first and second elongate portions 71, 72, respectively in the first and second holding portions 41b6, 41b7. In this modified form, as shown in FIG. 11, the aforementioned second and third rectangular portions 76, 77 are eliminated from the plate-like member 70. Other configurations in the modified form are the same as those in the foregoing embodiment and therefore, are omitted from detailed description in exchange for the allotment of the same reference numerals thereto.

In this modified form, as shown in FIG. 12, the plate-like members 70 are blanked out from the blank M1 of the width W1 at the layout angle α and at an interval P3. As mentioned earlier, by the elimination of the aforementioned second and third rectangular portions 76, 77, the interval P3 becomes much smaller in value than the aforementioned interval P2. The interval P3 represents the interval between the same portions of the adjoining plate-like members 70 in the lengthwise direction of the blank M1. As a result, since the bus bar 60 can reliably attached to the base portion 41b without provisions of the respective rectangular portions 76, 77, 78, 79, it can be realized to increase the yield in manufacturing the plate-like members 70.

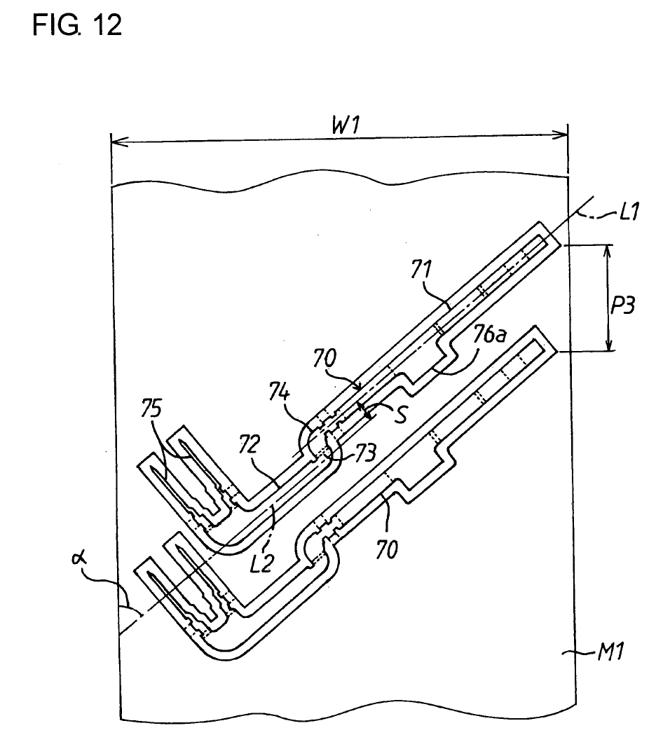

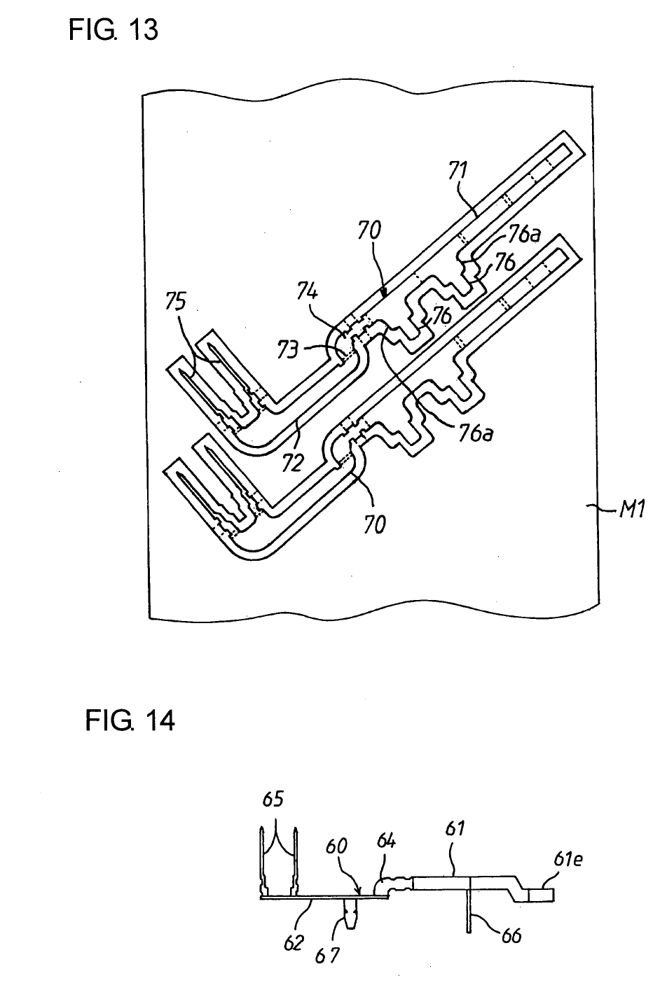

In the foregoing embodiment, the plate-like member 70 has respective rectangular portions formed at the first and second elongate portions 71, 72. Instead, in a further (fourth) modified form shown in FIG. 13, the rectangular portions may be formed at the first elongate portion 71 only. For example, it is preferable to provide a plurality (e.g., two) of the second rectangular portions 76, as illustrated in FIG. 13. As a consequence, a step of bending a rectangular portion which would otherwise be provided at the second elongate portion 72 becomes unnecessary, and hence, the manufacturing steps for the plate-like member 70 can be decreased.

In a still further (fifth) modified form of the foregoing embodiment, the connection portion 61e (the connection portion forming portion 71e) may be offset from the first path portion 61 (the first elongate portion 71), as shown in FIG. 14. This enables the connection portion 61e to go away from the control board 50, so that the chance for interference therebetween can be decreased.

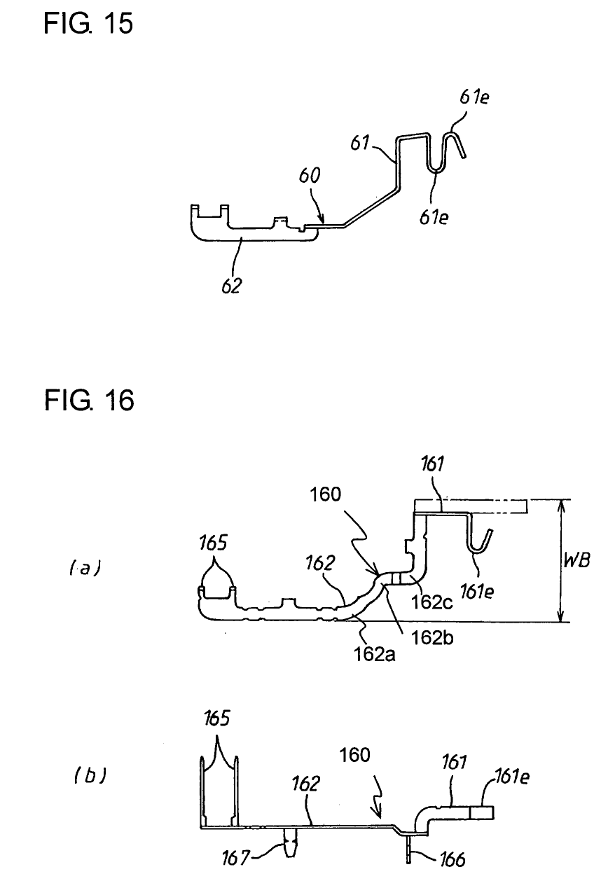

In a yet further (sixth) modified form of the foregoing embodiment, as shown in FIG. 15, there may be provided a plurality (e.g., two) of connection portions 61e for connection with lead terminals. In this modified form, it is required to make the connection portion forming portion 71e longer than that in the foregoing embodiment. Since the connection portions 61e are formed by bending the connection portion forming portion 71e several times from the state in which it lies in a plane, it can be realized to form the plurality of connection portions 61e easily at a high yield rate.

Various features and many of the attendant advantages in the foregoing embodiment as well as in the foregoing modifications will be summarized as follows:

In the bus bar and the circuit unit in the foregoing embodiment typically shown in FIGS. 2 through 5, the plate-like member 70 is formed approximately linearly because the first and second elongate portions 71, 72 each extending linearly are tied at a predetermined angle θ1. Thus, where a plurality of plate-like members taking the same shape as the aforementioned plate-like member 70 are blanked out in the sequential transfer line (not shown), the interval P1 between two adjoining plate-like members 70 can be made to be short, and therefore, it can be realized to suppress the deterioration in the yield in comparison with that in a prior art and hence, to suppress an increase in the manufacturing cost. Then, by bending the plate-like member 70, the electric conductor (bus bar) 60 can be formed to have the shape which follows the predetermined circuit path including the bent portions 61a-61d. Therefore, the electric conductor 60 can be formed to the shape which follows the predetermined circuit path including the bent portions 61a-61d, without deteriorating the yield and hence, without increasing the manufacturing cost. In addition, since the first elongate portion 71 is bent from the state in which it lies in a plane, it is possible to arbitrarily set the circuit path of the electric conductor (bus bar) 60.

Also in the foregoing embodiment typically shown in FIGS. 4 and 5, since the first elongate portion 71 is offset through the tying portion 74 by the distance S from the second elongate portion 72 in the direction perpendicular to at least one of the extending directions of the first and second elongate portions 71, 72, the bending line portion 73 can be certainly secured. Further, it can be realized to make the machining easy by shortening the length of the bending line portion 73.

In the first modified form shown in FIG. 6, the first predetermined angle θ1 is set to an angle which is not zero degree. Thus, where the first predetermined angle θ1 is made to be greater than zero degree without the alternation in the length in the lengthwise direction of the first elongate portion 71 (or the second elongate portion 72), the length of the plate-like member 70 in the lengthwise direction becomes shorter in comparison with that in the case of the first predetermined angle θ1 being zero degree. Thus, since the material (blank) M2 of the width W2 being narrower can be used as a blank for the sequential transfer line, it becomes possible to reduce the material cost.

Also in the foregoing embodiment typically shown in FIGS. 4 and 5, the plate-like member 70 is further provided with the first rectangular portions 75 being elongate and formed bodily at the second elongate portion 72 perpendicularly of the same. By being bent, the first rectangular portions 75 constitute lead terminals 65 for the electric conductor (bus bar) 60 connected to the first connection destination, that is, to the control board 50. The electric conductor (bus bar) 60 is attached to the base portion 41b with the second path portion 62 being held in surface contact with the base portion 41b. Thus, where a temperature change causes the lead terminals 65 to expand or contract, the stress which such expansion and contraction applies to the juncture between the first connection destination (control board 50) and each read terminal 65 can be relieved through elastic deformation of the second path portion 62.

Also in the foregoing embodiment typically shown in FIGS. 3-5, the plate-like member 70 is provided with a second rectangular portion 76 which constitutes a first insert portion 66 of the electric conductor (bus bar) 60. The first insert portion 66 extends from the first elongate portion 71 perpendicularly of the same and is bent to be insertable into the first socket hole 41b1 formed in the base portion 41b. The plate-like member 70 is further provided with the third rectangular portion 77 which constitutes the second insert portion 67 of the electric conductor (bus bar) 60. The second insert portion 67 extends from the second elongate portion 72 perpendicularly of the same and is bent to be insertable into the second socket hole 41b2 formed in the base portion 41b. Thus, the electric conductor (bus bar) 60 constituted by bending the plate-like member 70 can be attached reliably to the base portion 41b.

In the second modified form shown in FIGS. 7-9, the plate-like member 70 is further provided with the fourth rectangular portion 78 constituting the first engaging portion 66 of the electric conductor (bus bar) 60 which extends from the first elongate portion 71 in the direction perpendicular to the same. The first engaging portion 66 has the first engaging hole 78a and is bent to be fittable on the first engaging protruding portion 41b4 formed on the base portion 41b. The plate-like member 70 is further provided with the fifth rectangular portion 79 constituting the second engaging portion 67 of the electric conductor (bus bar) 60 which extends from the second elongate portion 72 in the direction perpendicular to the same. The fifth rectangular portion 79 has the second engaging hole 79a fittable on the second engaging protruding portion 41b5 formed on the base portion 41b. Thus, the fourth rectangular portion 78 and the fifth rectangular portion 79 can be made to be smaller in dimension, and hence, the yield in manufacturing the plate-like member 70 can be enhanced.

In the third modified form shown in FIGS. 10 and 12, the first elongate portion 71 is fitted in the first holding portion 41b6 which protrudes from the base portion 41b, and the second elongate portion 72 is fitted in the second holding portion 41b7 which protrudes from the base portion 41b. Thus, since the electric conductor (bus bar) 60 can be attached reliably to the base portion 41b without providing any elongate rectangular portions like those aforementioned, the yield in manufacturing the plate-like member 70 can be further enhanced.

In the fourth modified form shown in FIG. 13, the plate-like member 70 is provided with the rectangular portions 76 at the first elongate portion 71 only. Thus, the step of bending any rectangular portion which would otherwise be provided at the second elongate portion 72 becomes unnecessary, and hence, the manufacturing steps for the plate-like member 70 can be decreased.

Obviously, numerous further modifications and variations of the present invention are possible in light of the above teachings. It is therefore to be understood that within the scope of the appended claims, the present invention may be practiced otherwise than as specifically described herein.

What is claimed is:

1. An electric conductor formed to a shape which follows a predetermined circuit path including bent portions by bending a metal-made plate-like member spreading in a single plane and attachable to a base portion of a device, the plate-like member being made as a single integral member and comprising:
a first elongate portion formed linearly and constituting a first path portion of the electric conductor including the bent portions by being bent from the state in which the first elongate portion lies in a plane;
a second elongate portion formed linearly and constituting a second path portion of the electric conductor; and
a tying portion tying the first elongate portion and the second elongate portion so that an extending direction of the first elongate portion makes a first predetermined angle with an extending direction of the second elongate portion, the tying portion being bent so that a plane including the second elongate portion makes a second predetermined angle with a plane including the first elongate portion.

2. The electric conductor as set forth in claim 1, wherein the first elongate portion is offset through the tying portion from the second elongate portion in a direction perpendicular to at least one of the extending directions of the first and second elongate portions.

3. The electric conductor as set forth in claim 1, wherein the first predetermined angle is set to an angle which is not zero degree.

4. The electric conductor as set forth in claim 2, wherein the first predetermined angle is set to an angle which is not zero degree.

5. The electric conductor as set forth in claim 1, wherein:
the plate-like member further comprises a first rectangular portion being elongate and formed bodily at the second elongate portion perpendicularly of the same;
by being bent, the first rectangular portion constitutes a lead terminal for the electric conductor connected to a first connection destination; and
the electric conductor is attached to the base portion with the second path portion being held in surface contact with the base portion.

6. The electric conductor as set forth in claim 2, wherein:
the plate-like member further comprises a first rectangular portion being elongate and formed bodily at the second elongate portion perpendicularly of the same;
by being bent, the first rectangular portion constitutes a lead terminal for the electric conductor connected to a first connection destination; and
the electric conductor is attached to the base portion with the second path portion being held in surface contact with the base portion.

7. The electric conductor as set forth in claim 3, wherein:
the plate-like member further comprises a first rectangular portion being elongate and formed bodily at the second elongate portion perpendicularly of the same;
by being bent, the first rectangular portion constitutes a lead terminal for the electric conductor connected to a first connection destination; and
the electric conductor is attached to the base portion with the second path portion being held in surface contact with the base portion.

8. A circuit unit comprising:
a base portion of the circuit unit; and
an electric conductor formed to a shape which follows a predetermined circuit path including bent portions by bending a metal-made plate-like member spreading in a single plane and attached to the base portion,
wherein the plate-like member is made as a single integral member and comprises:
a first elongate portion formed linearly and constituting a first path portion of the electric conductor including the bent portions by being bent from the state in which the first elongate portion lies in a plane;
a second elongate portion formed linearly and constituting a second path portion of the electric conductor; and
a tying portion tying the first elongate portion and the second elongate portion so that an extending direction of the first elongate portion makes a first predetermined angle with an extending direction of the second elongate portion, the tying portion being bent so that a plane including the second elongate portion makes a second predetermined angle with a plane including the first elongate portion.

9. The circuit unit as set forth in claim 8, wherein the first elongate portion is offset through the tying portion from the second elongate portion in a direction perpendicular to at least one of the extending directions of the first and second elongate portions.

10. The circuit unit as set forth in claim 8, wherein the first predetermined angle is set to an angle which is not zero degree.

11. The circuit unit as set forth in claim 9, wherein the first predetermined angle is set to an angle which is not zero degree.

12. The circuit unit as set forth in claim 8, wherein:
the plate-like member further comprises a first rectangular portion being elongate and formed bodily at the second elongate portion perpendicularly of the same;
by being bent, the first rectangular portion constitutes a lead terminal for the electric conductor connected to a first connection destination; and
the electric conductor is attached to the base portion with the second path portion being held in surface contact with the base portion.

13. The circuit unit as set forth in claim 9, wherein:
the plate-like member further comprises a first rectangular portion being elongate and formed bodily at the second elongate portion perpendicularly of the same;
by being bent, the first rectangular portion constitutes a lead terminal for the electric conductor connected to a first connection destination; and
the electric conductor is attached to the base portion with the second path portion being held in surface contact with the base portion.

14. The circuit unit as set forth in claim 11, wherein:
the plate-like member further comprises a first rectangular portion being elongate and formed bodily at the second elongate portion perpendicularly of the same;
by being bent, the first rectangular portion constitutes a lead terminal for the electric conductor connected to a first connection destination; and
the electric conductor is attached to the base portion with the second path portion being held in surface contact with the base portion.

15. The circuit unit as set forth in claim 12, wherein a base end portion of the lead terminal at the second path portion of the electric conductor is spaced away from the base portion.

16. The circuit unit as set forth in claim 8, wherein the plate-like member further comprises:
a second rectangular portion constituting a first insert portion of the electric conductor, the first insert portion extending from the first elongate portion in a direction perpendicular to the same and inserted into a first socket hole formed in the base portion; and
a third rectangular portion constituting a second insert portion of the electric conductor, the second insert portion extending from the second elongate portion in a direction perpendicular to the same and bent to be inserted into a second socket hole formed in the base portion.

17. The circuit unit as set forth in claim 8, wherein the plate-like member further comprises:
a fourth rectangular portion constituting a first engaging portion of the electric conductor, the first engaging portion extending from the first elongate portion in a direction perpendicular to the same and having a first engaging hole, the first engaging portion being bent to be fitted at the first engaging hole on a first engaging protruding portion formed on the base portion; and
a fifth rectangular portion constituting a second engaging portion of the electric conductor, the second engaging portion extending from the second elongate portion in a direction perpendicular to the same and having a second engaging hole fitted on a second engaging protruding portion formed on the base portion.

18. The circuit unit as set forth in claim 8, wherein:
the first elongate portion is fitted in a first holding portion which protrudes from the base portion; and
the second elongate portion is fitted in a second holding portion which protrudes from the base portion.

19. The circuit unit as set forth in claim 16, wherein the plate-like member has the respective rectangular portions formed at the first elongate portion only.

20. The circuit unit as set forth in claim 17, wherein the plate-like member has the respective rectangular portions formed at the first elongate portion only.
